(19) United States
(12) Patent Application Publication
(10) Pub. No.: US 2023/0052903 A1
(43) Pub. Date: Feb. 16, 2023

(54) SYSTEM AND METHOD FOR MULTI-TASK LIFELONG LEARNING ON PERSONAL DEVICE WITH IMPROVED USER EXPERIENCE

(71) Applicant: HUAWEI TECHNOLOGIES CO., LTD., Shenzhen (CN)

(72) Inventors: Sahisnu Mazumder, Chicago, IL (US); Lifeng Liu, Sudbury, MA (US); Jian Li, Waltham, MA (US)

(73) Assignee: HUAWEI TECHNOLOGIES CO., LTD., Shenzhen (CN)

(21) Appl. No.: 17/947,937

(22) Filed: Sep. 19, 2022

Related U.S. Application Data
(63) Continuation of application No. PCT/US2020/023827, filed on Mar. 20, 2020.

(51) Int. Cl. G06N 20/20; G06K 9/62; G06N 5/02; G06F 11/34

(52) U.S. Cl. CPC G06N 20/20; G06K 9/6215; G06N 5/022; G06F 11/3438

(57) ABSTRACT

This disclosure relates to recommendations made to users based on learned behavior patterns. User behavior data is collected and grouped according labels. The grouped user behavior data is labeled and used to train a machine learning model based on features and tasks associated with the classification. User behavior is then predicted by applying the trained machine learning model to the collected user behavior data, and a task is recommended to the user.

### CLAIM OF PRIORITY

This application is a continuation of PCT Patent Application No. PCT/US2020/023827, entitled “SYSTEM AND METHOD FOR MULTI-TASK LIFELONG LEARNING ON PERSONAL DEVICE WITH IMPROVED USER EXPERIENCE”, filed Mar. 20, 2020, the entire contents of which is hereby incorporated by reference.

### FIELD

The disclosure generally relates to a personal device with a proactive personal assistant for lifelong learning of user behaviors in which to autonomously recommend an action or task to the user.

### BACKGROUND

Users are increasingly turning to smart devices, such as mobile phones, to augment and direct daily activities. Improved learning and anticipation of end-user behavior would improve the usefulness of smart devices in fulfilling the role of intelligent companions or electronic personal assistants on the smart devices that recommend, guide, and direct end user behavior. Some applications attempt to aid users by anticipating user actions based on collected user data and information. While such applications may attempt to understand the behaviors of the user by classifying the collected user data and information, there are numerous limitations as to the accuracy and value of the assistance provided by the application as the collected user data and information are too simplistic, generic, broad or vague to accurately predict how the user may respond to the incoming data.

### BRIEF SUMMARY

According to one aspect of the present disclosure, there is a computer-implemented method for providing recommendations to a user based on learned user behavior, comprising collecting user behavior data, from one or more sources, of a first user during a current time interval in relation to a context of a surrounding environment, the collected user behavior data enriched with associated information; grouping the user behavior data by labels, each of the grouped user behavior data labeled with a corresponding task classification and the grouped user behavior data training a first machine learning model; proactively predicting an expected user behavior data during a future time interval by applying the trained first machine learning model to the collected user behavior data, and recommending a task to the first user based on the expected user behavior and a threshold associated with each task classification; obtaining feedback from the first user and continuously learning patterns in the collected user behavior data to refine the trained first machine learning model based on the feedback and changes to the user behavior data; and storing the trained first machine learning model into a knowledge base for continued and multi-task learning.

Optionally, in any of the preceding aspects, the method further comprising collecting the user behavior data of one or more second users to continuously learn patterns in the collected user behavior data in which to predict the expected user behavior data.

Optionally, in any of the preceding aspects, wherein refining the trained machine learning model comprises continuously tracking the first user to collect additional user behavior data, storing the additional user behavior data in a data buffer, wherein the additional user behavior data is stored in a time sequence; removing the additional user behavior data stored in the data buffer that appears earlier in the time sequence and appending the additional user behavior data stored in the data buffer that appears later in the time sequence, when the data buffer is full; and retraining the trained first machine learning model with the first user behavior data remaining in the data buffer.

Optionally, in any of the preceding aspects, wherein the threshold is adaptively learned over a period of time and provides a basis of measurement in which to ensure that the predicting satisfies a level of confidence; and the task is recommended to the first user when the prediction satisfies the threshold.

Optionally, in any of the preceding aspects, wherein detecting similarities comprises comparing similarity metrics between the trained first machine learning model of the first user and a trained second machine learning model of a second user for a same task; and computing the similarity metrics for the trained first machine learning model and trained the second machine learning model.

Optionally, in any of the preceding aspects, wherein detecting similarities comprises combining a set of commonly learned tasks for the first and second users to determine the similarity metrics between the first and second users based on the computed similarity metrics of learned models for the tasks in the set of commonly learned tasks.

Optionally, in any of the preceding aspects, wherein detecting similarities comprises determining a subset of tasks from the group of tasks, the subset of tasks having a same task classification as the task to be predicted; extracting meta-data from each of the tasks in the subset of tasks into a single document; applying an information retrieval method to measure the document similarity as the task similarity with the task to recommend; sorting and determining the most similar task within the group of tasks to the task to recommend; and applying the associated learned machine model for the task to recommend.

Optionally, in any of the preceding aspects, wherein detecting similarities comprises for a new task for the first user, determining the most similar learned machine model from the most similar second user based on the combined similarity metrics using user similarities and task similarities and using the learned model to recommend for the new task; and recommending the new task to the first user based on applying the learned machine model.

Optionally, in any of the preceding aspects, wherein the associated information is enrichment data collected from third party sources.

According to one other aspect of the present disclosure, there is provided a personal assistant on a mobile device to provide recommendations to a user based on learned user behavior, comprising one or more sensors for sensing user behavior data; a non-transitory memory storage comprising instructions; and one or more processors in communication with the memory and the one or more sensors, wherein the one or more processors execute the instructions to: collect user behavior data, from the one or more sensors, of a first user during a current time interval in relation to a context of a surrounding environment, the collected user behavior data enriched with associated information; group the user behavior data by labels, each of the grouped user behavior data labeled with a corresponding task classification and the grouped user behavior data training a first machine learning model; proactively predict an expected user behavior data during a future time interval by applying the trained first machine learning model to the collected user behavior data, and recommending a task to the first user based on the expected user behavior and a threshold associated with each task classification; obtain feedback from the first user and continuously learning patterns in the collected user behavior data to refine the trained first machine learning model based on the feedback and changes to the user behavior data; and store the trained first machine learning model into a knowledge base for continued and multi-task learning.

According to still one other aspect of the present disclosure, there is a non-transitory computer-readable medium storing computer instructions for providing recommendations to a user based on learned behavior, that when executed by one or more processors, cause the one or more processors to perform the steps of collecting user behavior data, from one or more sources, of a first user during a current time interval in relation to a context of a surrounding environment, the collected user behavior data enriched with associated information; grouping the user behavior data by labels, each of the grouped user behavior data labeled with a corresponding task classification and the grouped user behavior data training a first machine learning model; proactively predicting an expected user behavior data during a future time interval by applying the trained first machine learning model to the collected user behavior data, and recommending a task to the first user based on the expected user behavior and a threshold associated with each task classification; obtaining feedback from the first user and continuously learning patterns in the collected user behavior data to refine the trained first machine learning model based on the feedback and changes to the user behavior data; and storing the trained first machine learning model into a knowledge base for continued and multi-task learning.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

Aspects of the present disclosure are illustrated by way of example and are not limited by the accompanying figures for which like references indicate elements.

FIG. 1 illustrates an example system to collect data and predict user behavior.

FIG. 2 illustrates an example learning system in accordance with embodiment of the disclosure.

FIG. 3 illustrates an example of digital trace information collected from a user browsing session on the web.

FIGS. 4 and 5 illustrate examples of data enrichment information.

FIG. 6 illustrates and example of an interactive conversation between a user and the prediction system (personal assistant).

FIGS. 7A and 7B illustrate an example of the task dependent learning in FIG. 2.

FIGS. 8A-8D illustrate flow diagrams for recommending tasks to a user based on learned behavior in accordance with embodiments of the disclosure.

FIG. 9 shows an example embodiment of a computing system for implementing embodiments of the disclosure.

### DETAILED DESCRIPTION

The present disclosure will now be described with reference to the figures, which in general relate to technology for establishing a trusted relationship in a distributed system.

A lifelong learning system combines both multi-user and multi-task knowledge, in which to proactively make recommendations and suggestions based on learned user behaviors and contextual information. User behavior and contextual information are collected, and the information is used to train models. Once trained, the learned models may be applied to generate the recommendations and suggestions. Since the lifelong learning system continuously measures and learns user behaviors and contextual information, a buffer on the device (or in the cloud) stores the information and updates the information in the models in order to adapt with user behavioral (and contextual information) changes. Using this learning system, knowledge transfer becomes possible across-devices, users and tasks.

As explained below, implementation of the lifelong learning system achieves high precision in prediction. Use applications include, for example, organizing app icons to a home screen of a user device based on context and situational awareness for easy access; pre-launch of load-intensive apps (e.g., games with intense graphics) and a reduction in waiting time or latency; power optimization by forcing a shutdown of memory-intensive background apps when the user is predicted not to use them in the immediate future, etc.

It is understood that the present embodiments of the disclosure may be implemented in many different forms and that claim scope should not be construed as being limited to the embodiments set forth herein. Rather, these embodiments are provided so that this disclosure will be thorough and complete and will fully convey the inventive embodiment concepts to those skilled in the art. Indeed, the disclosure is intended to cover alternatives, modifications and equivalents of these embodiments, which are included within the scope and spirit of the disclosure as defined by the appended claims. Furthermore, in the following detailed description of the present embodiments of the disclosure, numerous specific details are set forth in order to provide a thorough understanding. However, it will be clear to those of ordinary skill in the art that the present embodiments of the disclosure may be practiced without such specific details.

Artificial Intelligence (AI) and machine learning (ML) have become a driving force of mobile device growth. Many mobile devices now include personal (intelligent) assistants (or personal digital assistants) or services that retrieve information or execute tasks on behalf of a user. Users can communicate with the personal assistants using an interface on the mobile device. Enhancing the personal assistant's ability to become context-aware and personalized can improve a user's experience and engagement. However, most of the AI- and ML-based solutions are driven by specific and limited goals with limited situational awareness. For example, AI in a mapping app may make recommendations to a user based solely on location history previously learned by the app without consideration of other activities or factors, such as how the weather or an accident affected the recommendation. In another example, AI in a music app may learn about a user's specific musical interests in songs and make recommendations accordingly. However, the music app may not consider additional information, such as when the user likes to listen music or a user's current situation (e.g., located in a library versus working out). In one further example, Sherpa.ai™ predicts the information with interest (Raining? Sherpa recommends grabbing an umbrella). However, Sherpa.ai learns based on when a user is using the application and does not acquire knowledge across other systems, devices and users. Other examples include voice assistants, such as Siri™, Alexa™, Cortana™ Google Assistant™, etc., which work as “Reactive Intelligence” where the user initiates interactions and the assistant performs actions based on instructions based on a limited set of knowledge.

Another challenge in machine learning, particularly on mobile devices, is the security of private information. When training a learning model via a network (e.g., sending information to a server in the cloud), users' information is collected across the network, which creates a potential for privacy compromise or accuracy issues. While some systems limit the transfer of private information, they present other issues. As an example, privacy-preserving federated learning by Google™ can train a model by combining multiple users' learning results without exchanging user information. However, the system generally only serves a single model and a single task. Moreover, how to share learned knowledge between different users for different prediction tasks and how to improve prediction precision via adaption are still unresolved issues.

Additional challenges presented to AI and ML-based systems is that ever more powerful computing devices, such as mobile phones, are increasingly executing multiple tasks simultaneously. For AI and ML-based systems to train and learn models in this environment, multi-task learning and transfer learning techniques are employed. Multi-task and transfer learning includes, for example, training models on one task and transferring the learned knowledge to a new task, training models on many tasks and transferring to a new task, etc. However, previously identified tasks alone do not identify how to solve problems in a target domain.

To resolve these issues and more, this disclosure provides a personal assistant that continuously and securely learns from user behaviors and situations to proactively recommend actions, i.e. learn shared knowledge about usage activities across different users and different tasks without compromising privacy and at the same time leveraging the knowledge across devices, tasks and users.

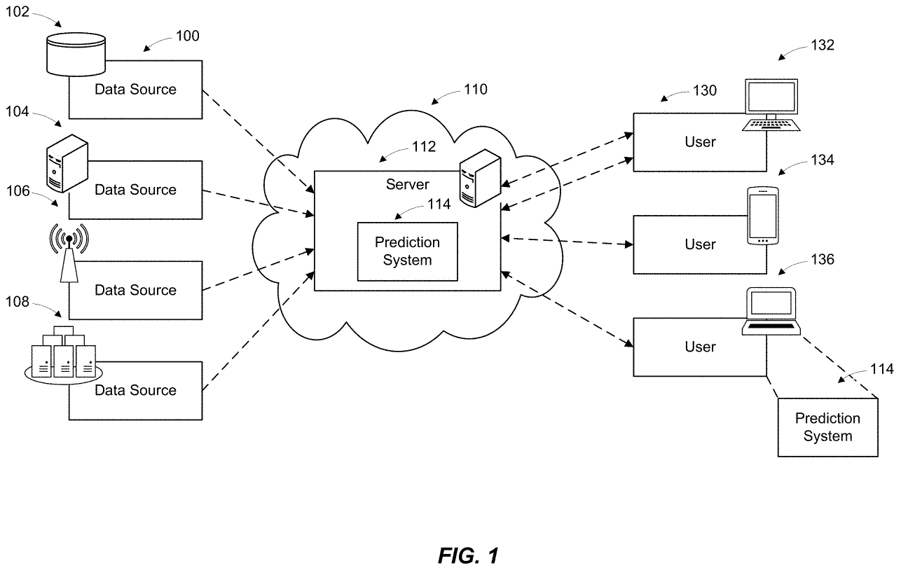

FIG. 1 illustrates an example system to collect data and predict user behavior. The system includes a server 112, with a prediction system 114, for collecting data during a current time interval (or period) and predicting the user behavior (or sequence of behavior) at a future time interval in response to the collected data. In one embodiment, the prediction system 114 is a personal assistant that resides on the server 112 and/or the computing device 132-136 of user 130.

In one embodiment, the personal assistant can be an application or module (e.g., Siri or Alexa) that configures or enables the computing device to interact with, provide content to and/or otherwise perform operations on behalf of the user. In doing so, the personal assistant may leverage or communicate with the prediction system 114 to predict or recommend an output to the user 130. For example, a personal assistant can receive communications and/or request(s) from users and present responses to such request(s) (e.g., within a conversational or ‘chat’ interface). In certain implementations, the personal assistant can also identify content that can be relevant to the user (e.g., based on a location of the user or other such context) and present such content to the user. The personal assistant can also proactively assist or recommend to the user to initiate and/or configure other application(s). For example, a user can provide a command/communication to personal assistant (e.g., ‘watch videos’). In response to such command, the personal assistant can initiate an application (e.g., a media player application) that fulfills the request provided by the user. In one embodiment, the personal assistant may proactively initiate the application based on learned information about the user, as described herein below.

As illustrated, the server 112 is located within network 110, such as a cloud-based network, and may facilitate the collection of data from a variety of different data sources 102, 104, 106, which data may be delivered to one or more users 130. Server 112 can be, for example, a server computer, computing device, storage service (e.g., a ‘cloud’ service), etc. The network may include, but is not limited to, one or more local area networks (LANs), wide area networks (WANs), the Internet, cellular communications networks, or any other public or private network. In one embodiment, the collected data is indicative of user behavior.

In one example, the user 130 may receive different types of data from multiple data sources 100, such as a database 102, a server 104, a wireless access point 106, a data center 108, including email messages, text messages, instant messages, voicemail messages, phone calls, multimedia and/or audiovisual messages, documents, RSS feeds, social network updates, and other similar alerts and data. In one embodiment, the user 130 may communicate with the server 112 over the cloud-based network 110 and may receive the data over the cloud-based network 110 via a plurality of computing devices, such as a laptop computer 136, a desktop computer 132, a smart phone 134, a mobile phone, a tablet, and/or a home automation device. In one other embodiment, the computing devices 132-136 operate as the data source to collect data about the user that is indicative of the user's behavior. For example, sensors or cameras in the computing devices 130 may collect data.

In another example embodiment, upon receipt of incoming data over the cloud-based network 110 at the user's individual computing device (or collected by the computing device), the user 130 may respond to the incoming data by executing a particular action (or task). For example, in response to receipt of an email message, the user 130 may read and respond to the email, ignore, prioritize the email, delete the email, flag the email, move the email to a particular categorized folder, and/or save the email for later, as some example response actions. As another example, if the user 130 receives a calendar alert and/or an event request, the user may add the event to the user's personal calendar, and also may categorize the event as a work or personal event, and may mark the event as important. As yet another example, when the user receives a text message, some available response actions the user may take may include reading, responding, deleting, or saving the message for later. The above example response actions represent some available actions the user may take in response to incoming data. These actions may also be collected by the server 112 (or directly by the computing devices 132-136) and stored for processing by the prediction system 114 to interpret as user behavior data. In a further example, the user may read, edit, delete, or forward a received document depending on which computing device the document was received on or which application was used to receive the document. Thus, the context and the content of the document may impact how the user responds to it. In this regard, the context of the action may be indicative of user behavior or be used as supplemental data to the actions performed by the user.

As mentioned above, the response actions the user 130 takes may depend on the context and subject of the data, the location of the user 130, the device on which user 130 receives the data, and the time and date when the user 130 receives the incoming data. For example, the user 130 may respond to particular incoming data during business hours and other types of incoming data during evening or off hours. As an example of location based response actions, the user 130 may respond to work related data while the user 130 is located at work, and may save the same data for reviewing later if the user 130 is at home or on vacation. Further, if the user 130 is driving in the car, the user 130 may not read or respond to the incoming data while in the car, and upon arriving at a destination, the user 130 may read and execute a response action.

In one embodiment, a user's history (or historical data) of interactions with incoming data may also be used in order to predict the actions or behavior of the user 130 in response current or incoming data. In one embodiment, shared knowledge of other user data (e.g., user behavior and actions) may be used to assist in predicting the actions and behavior of the user 130.

The prediction system 114 may be configured to observe the user 130 as the user receives the incoming data from one or more of the data sources 102, 104, 106 to identify what data the user 130 receives, and to identify what actions or behaviors the user 130 takes upon receipt of the data. The prediction system 114 may continuously track the user over a period of time (or time interval) and identify a pattern of user behavior and response to received incoming data. Based on the tracked pattern of user response to the incoming data, the prediction system 114 may be able to determine a probability of the user 130 taking certain actions in response to certain incoming data. Based on the determined probabilities, the prediction system 114 may predict what action the user 130 may take upon receipt of particular data. In one embodiment, the prediction system 114 resides in server 112. In another embodiment, the prediction system resides with the computing device, such as computing devise 132-136.

The prediction system 114 may be configured to predict a series of actions, when the actions are done, as well as context-based actions. For example, the prediction system 114 may recognize that in response to a particular incoming data, such as an email message, the user may read the message within an hour of receipt of the message and then reply to it. Additionally, the prediction system 114 may recognize the context and content of incoming data in order to predict user actions, such that upon receipt of an email message relating to the user's taxes or received from the user's accountant, the prediction system 114 may predict that the user 130 may save the email message to a “Tax Returns” folder stored on the user's personal computing device, for example. The prediction system 114 may also recognize that the user may print an attachment to an incoming message and/or may save an attachment to a designated folder on the user's computing device.

Based on the predicted actions, the prediction system 114 may be configured to recommend or suggest the predicted action to the user 130, await for user approval of the predicted action and/or proactively take action on behalf of the user 130. In another embodiment, the prediction system 114 may automatically perform the predicted action on behalf of the user 130. For example, the system may automatically save an email attachment to a labeled folder or mark an incoming message as high priority for response. The prediction system 114 may be configured to continuously observe the user actions in response to incoming data in order to continuously and dynamically update the determined probabilities and refine user action predictions in order to increase the accuracy of the predicted actions. Moreover, the prediction system 114 may be configured to monitor individual users, such that the prediction system 114 may make predictions of user action that are personalized to the specific observed user. The prediction system 114 may also be configured to monitor groups of users, such that a particular user's response action may be predicted based on group data observed and organized by the prediction system 114. For example, this may be done when a new user is enrolled in the system, to make useful predictions when no information about that specific user is available.

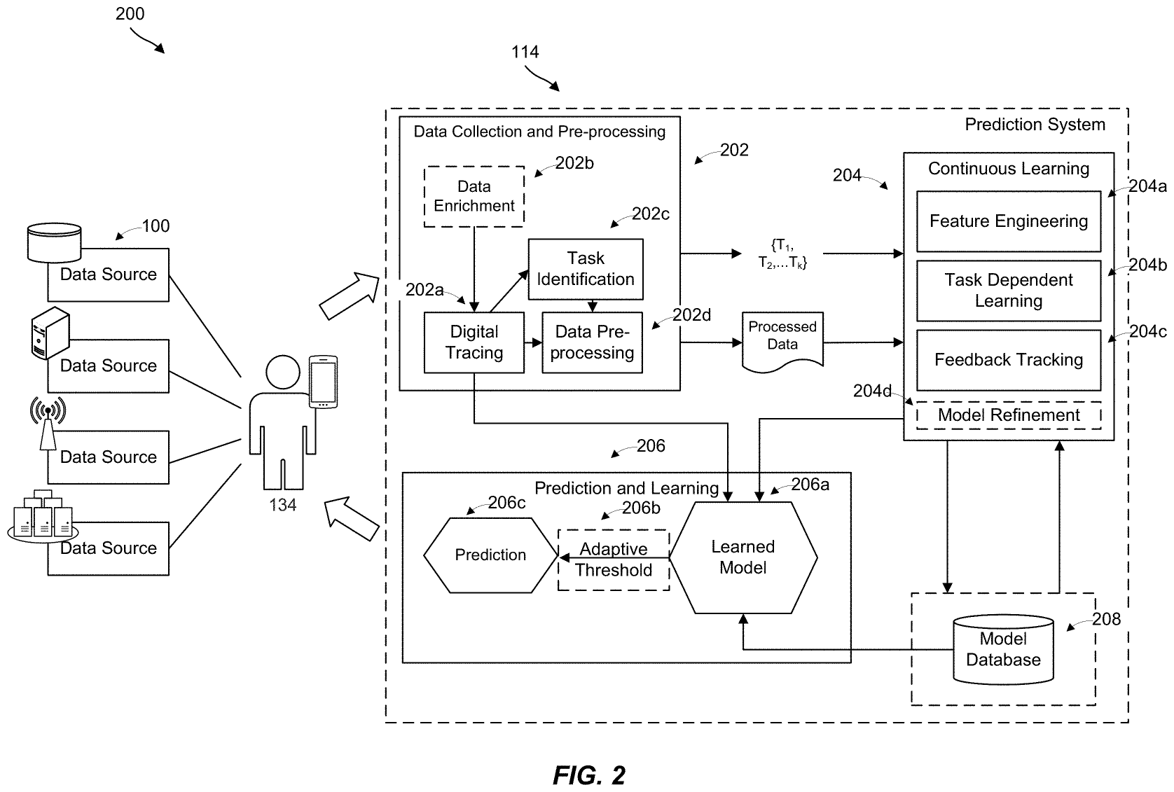

FIG. 2 illustrates an example learning system in accordance with embodiment of the disclosure. The learning system 200 learns from user behaviors, such as user activity, intent and contextual surrounding (situational awareness), and proactively recommends actions or tasks to the user 134 based on expected user behavior. In one embodiment, the learning system 200 learns shared knowledge about activities across different users and tasks (e.g. apps or user activity on the user's mobile device) without compromising privacy, and leverages the shared knowledge of other user behavior into a unified behavior prediction framework.

In the illustrated embodiment, the learning system 200 includes data sources 100 that provide data to user 134 and the prediction system 114. The prediction system 114 is comprised of a data collection and pre-processing environment 202 to collect user behavior, context and activity at intervals of time (e.g., 30 seconds), a continuous learning environment 204 to train models and learn predictions, a prediction and learning environment 206 to predict user actions based on user behavior data and feedback, and a model database 208 (or knowledge base) to store trained (and refined) learning models.

### Data Collection and Processing

The data collection and pre-processing environment 202 collects data from data sources. The collected data may be current or real-time data for one or more users, and may also include historical data that was previously collected. The data collected includes, but is not limited to, timestamp, location, physical activity (walking, still, running, driving, etc.), sensor readings (e.g., accelerometer, gyroscope, gravity, light, etc.), app usage (what apps user has used or is using), phone settings (notifications, wifi on/off, etc.), calendar events (past, current and future events of users for current day), etc. It is appreciated that while the term behavior data sometimes refers to information produced as a result of actions using various devices connected to the Internet (or a network), the term is not limited to such a definition. As used herein, the term behavior data may also include any data produced as a result of a user's actions that may be tracked and collected using any number of different devices, whether or not connected to a network, such as the Internet.

As part of the data collection process, digital traces (or footprints) 202a of a user 130 (or user's device) may be collected. Digital tracing of information generally refers to a unique set of traceable activities, actions, contributions and communications that are manifested on the Internet or on digital devices. For example, on the World Wide Web, the digital trace is the information left behind as a result of a user's web-browsing, typically stored at cookies. However, digital trace information is often meaningless without context or the contextual environment in which the data is collected.

Although not depicted, various detection and monitoring tools may be used to detect, observe, and/or monitor sensor data by facilitating one or more sensor and/or detectors, such as camera, microphone, touch sensors (e.g., touch pads, touch panels, etc.), capacitors, radio components, radar components, scanners, and accelerometers, etc. to capture objects within a scene. For example, sensor data may include information obtained through direct observation of a person, such as capturing images through a camera, voices or sounds through microphone, movements through other sensors, etc. The detection and monitoring tools in one embodiment may be remotely located from the user 134, such as data sources 100. The detection and monitoring tools in another embodiment may be located on the user device, such as a mobile phone. In one embodiment, the collected data may be classified using the prediction system for use in determining future behaviors and providing predictions and recommendations to the user, as described in more detail below.

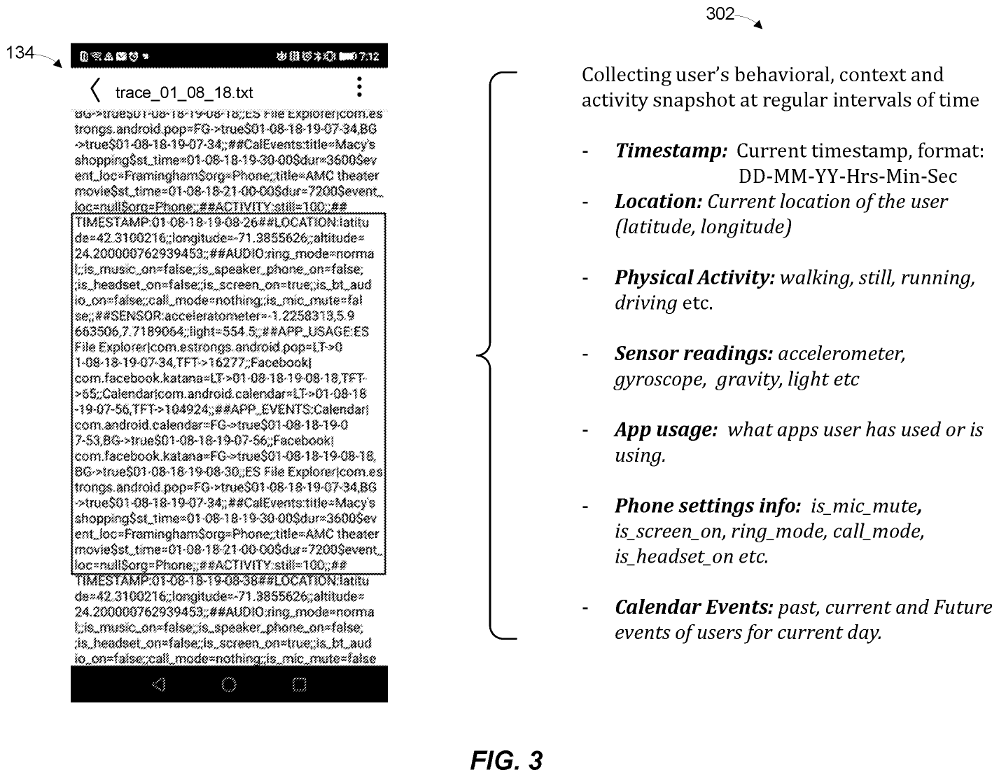

FIG. 3 illustrates an example of digital trace information collected from a user device. As illustrated, the digital trace 202a includes collection of the user's behavior, context and activity during a specified time interval. In one embodiment, the data is collected during regular time intervals or during randomly selected time intervals. The digital trace information 302 includes categories such as timestamp (e.g., day, month, year, hour, minutes, seconds), location (e.g., current location of the user), physical activity (e.g., walking, still, running, driving), sensor readings (e.g., accelerometer, gyroscope, gravity, light), app usage (e.g., apps user has used or is using), phone setting information (e.g., state of mic, screen, ring mode, call mode, headset mode), calendar events (e.g., past, current and future events of user), etc.

In one embodiment, the digital trace information 302 may be supplemented with data enrichment information supplied by data enrichment 202b. In one embodiment, the data enrichment information is collected from a third party source and merged with the user behavior data collected by the learning system 200. The data enrichment 202b service extracts, repairs, and enriches datasets, resulting in more precise entity resolution and correlation. Data enrichment can include a visual recommendation engine and language for performing large-scale data preparation, repair, and enrichment of heterogeneous datasets. This enables the user 130 to select and see how the recommended enrichments (e.g., transformations and repairs) will affect the user's data and make adjustments as needed. The data enrichment service can receive feedback from users through a user interface and can filter recommendations based on the user feedback (e.g., deep learning based on feedback tracking 204c). In some embodiments, the data enrichment can analyze data sets to identify patterns in the data.

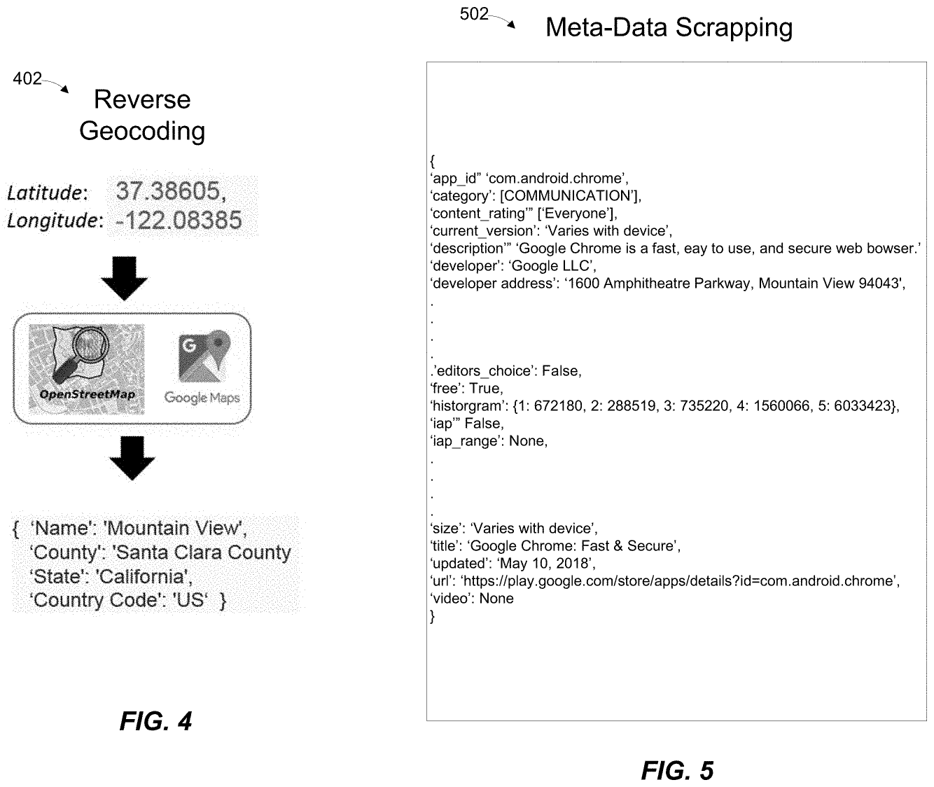

For example, FIGS. 4 and 5 illustrate examples of data enrichment information. In the example of FIG. 4, reverse geocoding 402 can be used to fetch a location's hierarchical structure of an address, which is useful to capture behavioral patterns at various levels of spatial granularity. For example, the user may be located at a latitude of 37.38606 and longitude of −122.08385, which equates to Mountain View, Santa Clara, Calif., USA. While in this location, the user may have daily routines that she follows. If the user (and user device 134) goes out of the country, her daily routine will change, as evidenced by a change in the reverse geocoding information.

In the example of FIG. 5, meta-data scrapping 502 of an apps meta-data can help to perform zero-shot lifelong learning. Meta-data scraping extracts data produced from human-readable output coming from another program. For example, the human-readable output shown in the figure may be “scraped” to extract information, such as the current version of the device or the developer address. Such extracted information may be used in task transfer or zero-shot learning, which refers to a specific use case of machine learning where the model classifies data based on very few, or even “zero,” labeled data. For example, a learned model for a task, for example “Adobe Reader,” for one user can be invoked to predict the status of a task, for example “Kindle,” for a like-minded user. Like-minded user examples are provided in more detail below.

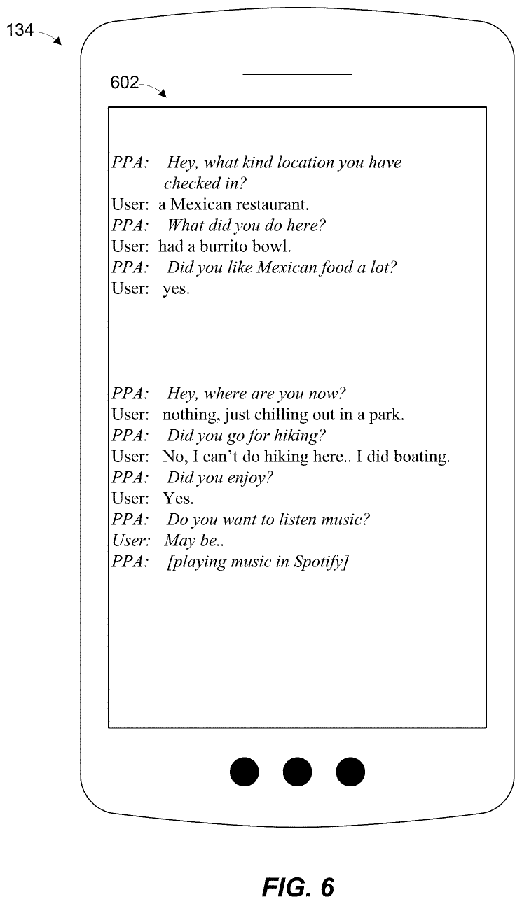

FIG. 6 illustrates and example of an interactive conversation between a user and the prediction system (personal assistant). In one embodiment, performance and capability of the prediction system depends upon situational-awareness and a fine behavioral understating. In some instances, passively tracing user behavior and activities, for example using sensors and location, is insufficient to capture the “finer” contextual details, and simply capturing data from third parties may be problematic due to privacy issues. In one embodiment, these issues may be resolved using an interactive learning agent, embedded in the prediction system, that permits conversing with the user 130 to leverage the prediction system to refine learning. Such conversing may be, for example, in the form of an interactive visual response agent 602, as illustrated in FIG. 6. In the example interactive visual response agent 602, a user of the computing device 134 interacts with the prediction system (personal assistant) to respond to questions posed by the assistant. The responses provided to the system may then be used as part of the lifelong learning process.

Turning back to FIG. 2, the data collection and pre-processing environment 202 also includes task identification 220c and pre-processing 202d environments. The task identification 220c identifies events or tasks T₁, T₂ . . . Tₖ about the user 134 from the collected data. That is, the task identification 220c can determine (or identify) an event or task T₁, T₂ . . . Tₖ of which the user is participating or involved. In general, identification of an event or task T₁, T₂ . . . Tₖ can enable prediction of future events or tasks likely attended by a user. For example, and for purposes of discussion, assume a user is at home as opposed to work. In predicting future events or tasks, it is more likely that a user will have lunch near home than near a work dining location. As another example, if a user opens a same app on her phone before eating a meal, it is likely that the app will be opened prior to the next meal or another meal.

In one embodiment, and during implementation, a current event or task may be determined using data identified from the collected user behavior data, contextual data (including current and/or historical data) and/or data collected for different users. In one example, a current or recent location of a user can be used to identify a current event or task, such as where a user is located, what a user is doing, etc. Assume for purposes of discussion, a user is identified as being located at a specific address known to be the user's business address. In such a case, recognizing that the user is located at their place of business enables identification that the current event or task includes the location of work. For example, if the user is in a meeting, the behavior may be predicted to be a business meeting since the location information has been identified as a business address. In another example, location information can be monitored continuously, periodically, or as needed. In some cases, the monitored location information may have a corresponding timestamp for when the location information was sensed or otherwise determined. Thus, a collection of location-time data may be determined that includes data points indicating a location (which may be a geographical location or semantic location) and a corresponding time that the location was detected. Accordingly, an event or task may be determined based on consecutive or sequential data points in the time-series that indicate the same approximate location.

In another embodiment, user location history information associated with previous visits to the current location may also be used for determining a current event or task. The task identification 202c may determine a current event or task using one or more historical events, such as historical visits to the same location as the current visit. In this regard, a current location associated with a user can be compared to other previous events or tasks indicated as having that same location. For example, a particular user location can be compared to locations at which a user has previously been located to identify a match of location. Based on the match of a location, a current user event or task can be determined, such as grocery shopping at a particular grocery store.

In addition to location data, other user behavior data and/or contextual data can be used to identify a current event or task. For example, user behavior data indicating user interactions may be used to identify a specific event or task a user is performing. For instance, while a user is located at the office, user interaction indicating a voice call (e.g., signals from an Internet connected telephone or computer telephony application, such as Skype) can be used to determine the user is participating in a voice call. In another example, other users' behavior data in combination with the user's location may be used to identify an event or task at which the user is present. For instance, when other users are identified as participating in an event or task and the user is located in the same or similar location, the event or task can be identified as the user's event. As appreciated, any different number of user behavior data and/or contextual data may be applied and used to identify a current event or task, and is not limited to the disclosed example embodiments.

Data pre-processing 202d configures the collected user behavior data into formats better suited for neural network consumption and training, and in particular, for supervised learning. In general, the data pre-processing 202d can pre-process data and utilize such pre-processed data to train machine learning models that generate resulting data, such as data predictions using classification, clustering, regression, anomaly detection, outlier detection, or the like. Pre-processed is defined herein as data that is processed prior to being used to generate or train a machine learning model. Pre-processing generally includes transforming raw data, such as raw machine data within events, to prepare the raw data for further processing. Such pre-processing may be, for instance, formatting, cleaning (e.g., removal or fixing of missing data), normalization, transformations, dimension reduction, feature extraction, and/or sampling data.

In one embodiment, pre-processing data can enable more robust training data that can be used to train or generate the machine learning model(s). In this regard, pre-processed data deemed appropriate for training the machine learning model can be used to generate a more accurate or appropriate machine learning model. For example, outlier data may be removed from an initial data set such that the machine learning model is not skewed in accounting for the outlier data. Upon performing data pre-processing, the pre-processed data can then be used to generate a machine learning model. The machine learning model can subsequently analyze data and output results, such as predictions or recommendations.

Pre-processing data methods include, but are not limited to, standard scalar, principal component analysis (PCA), and kernel PCA. A standard scalar pre-processing method generally normalizes numeric data. A PCA pre-processing method refers to a statistical procedure using an orthogonal transformation to convert observations of possibly correlated variables to values of linearly uncorrelated variables. A kernel PCA pre-processing method generally refers to an extension of PCA pre-processing method that uses techniques of kernel methods. Although pre-processing methods are provided as examples, any pre-processing method may be utilized in accordance with embodiments described herein.

### Continuous Learning and Model Refinement

As part of the pre-processing of data and continuous learning, the identified tasks T₁, T₂ . . . Tₖ and pre-processed data are used in conjunction with the continuous learning environment 204. Continuous leaning is a mechanism by which multiple tasks may be learned in sequence, with an emphasis on how previous knowledge of different tasks can be used to improve the training time and learning of current tasks. Using this mechanism, with repeated (continuous) learning indefinitely, the system can learn over the course of time (life-long learning) in order to make predictions or recommendations for future tasks or actions. The continuous learning environment 204 includes feature engineering 204a, task dependent learning 204b, deep learning based on feedback tracking 204c and model refinement 204d.

### Feature Engineering

Feature Engineering 204a refers to selecting and extracting the features from the data that are relevant to the task and model to be trained. Essentially, feature extraction creates a new, smaller set of features that captures the most useful information in the data. During the feature selection process, the most useful and relevant features are selected from the data. During feature extraction, existing features are combined to develop more useful ones. New features may also be added by collected new data (referred to as feature addition), and irrelevant features may be filtered out to provide for easier modeling (referred to as feature filtering). In general, there two separate techniques for feature selection—univariate and multivariate. Univariate feature selection is typically a manual selection of features. Multivariate features selection, when manual selection is not possible due to a large number of features, may be divided into several different methods, including but not limited to, a filter method, a wrapper method and an embedded method (discussed in detail below).

### Task Dependent Learning (Embedding)

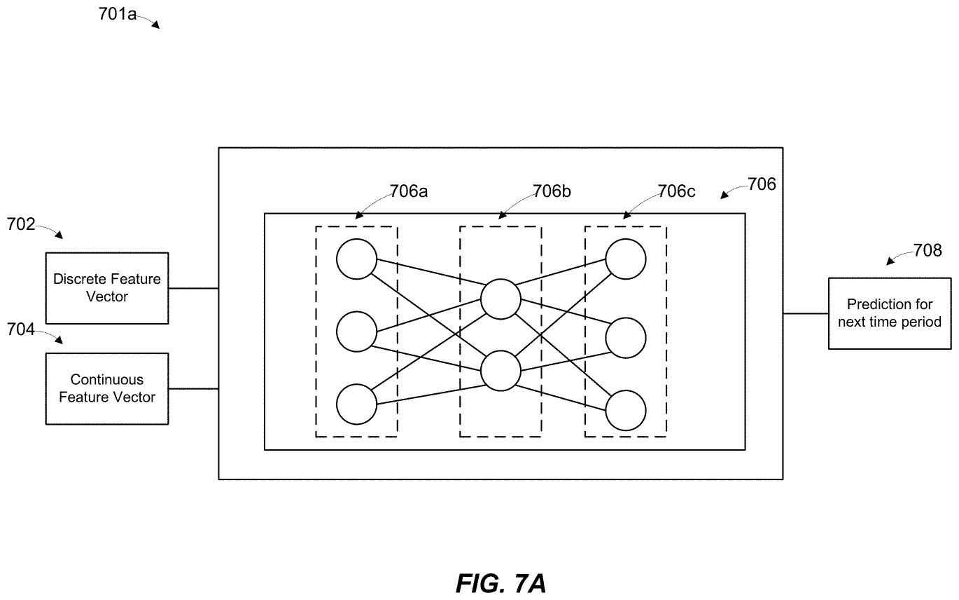

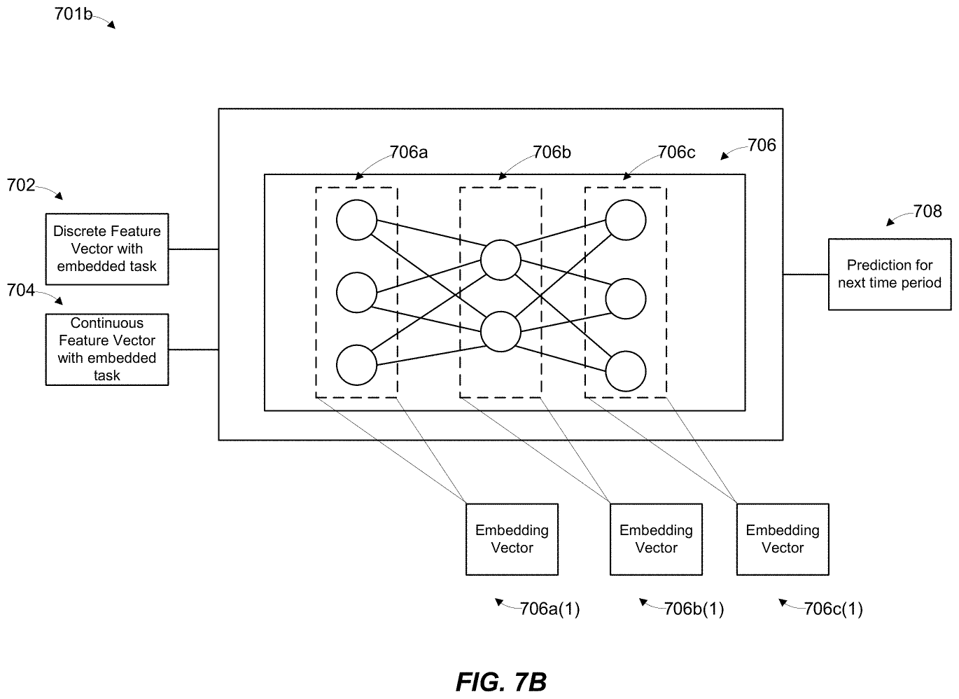

FIG. 7A illustrates an example of the task dependent learning in FIG. 2. In particular, the figure shows an example multi-layer perceptron (MLP) neural network for learning a single task prediction. The MLP network 701 learns a combined representation of discrete and continuous features. Discrete features may include, but are not limited to, temporal features, location features, phone settings information, app usage info, etc. Continuous features may include, but are not limited to, location latitude and longitude, physical activity confidence vector, sensor information, etc. Each layer is accompanied with batch normalization and dropout is applied at the final representation layer for regularization. The network (model) consumes context feature vectors corresponding to the observation at timestamp “t” for a user “u” (i.e., C_{T}^{u}) and predicts a label of task-N for a next (future) W time period. That is, given a current contextual snapshot (observation) ‘d’ of user “u” at timestamp “t” and a task-N and response time window of size W (mins), predict the activity (label) of task-N observed in the next W mins (i.e., [t+1, t+W]). In one embodiment, the response window is the time interval the prediction system 114 waits to gather a response from the user. For example, given ‘d’ at time ‘t,’ predict the class label of task-N and wait for the next “w” minutes [t+1, t+w] in which to check the user's reaction to gather a true class label. For example, based on the input feature vectors, the model will predict whether a user will use an app in a future time period.

In the example above, the prediction corresponds to the behavior of the predication system to proactively asses a user's immediate next action and make a recommendation. Once a recommendation is provided to the user, the user may provide a reaction or feedback within the next ‘w’ minutes. Once the ‘w’ minutes has expired, the true label for data instance ‘d’ is gathered. At this point, ‘d’ becomes a training example and takes part in the model learning. For example, suppose the prediction system 114 predicts the user will use “gmail” in next 5 minutes and observes behavior of the user for the response window. If the user uses “gmail” within next 5 minutes, its prediction for the current contextual snapshot ‘d’ is correct. Otherwise, the prediction is incorrect.

The MLP network 701 includes a deep neural network (DNN) 706 having an input layer 706a, an output layer 706c, and one or more hidden layers 706b between the input layer 706a and the output layer 706c. The input layer 706a receives the discrete feature vector 702 and the continuous feature vector 704 from a current frame (or time period). In one example, the information in input layer 706a is processed by one or more sigmoid layers that perform sigmoid functions within DNN 706, As understood by one skilled in the art, a sigmoid function can be used in artificial neural networks to introduce nonlinearity into the model. A neural network element can compute a linear combination of its input signals, and applies a sigmoid function to the result. The sigmoid function can satisfy a property between the derivative and itself such that it is computationally easy to perform.

In one example, hidden layer 706b includes a set of nodes that feed into a set of output nodes in output layer 706c, Based on the discrete feature vector 702 and the continuous feature vector 704, output layer 706c outputs a prediction output 708 indicative of a recommendation (e.g., a predicted task). In one example, the DNN 706 predicts a posterior probability for a future frame (time period), which can be the next contiguous frame (time period), following the current frame, or some other future frame. For instance, the prediction output can be a posterior probability of a state (e.g., of an app) for the future frame, based on the discrete feature vector 702 and the continuous feature vector 704 for the current frame. In one example, output layer 706c comprises a softmax function that converts raw value(s) into the posterior probability (i.e. prediction scores). That is, each result generated by the model may be associated with a value (or prediction score) that ranks the likelihood of the data matching the classification. The prediction score may be used to determine how the data may be classified, as is detailed further below.

FIG. 7B also illustrates an example of task dependent learning in FIG. 2. As shown in the figure, there is an example multi-layer perceptron (MLP) neural network for learning a multi-task prediction using feature embedding, where learning of features at each layer is conditioned on the feature representation. For example, similar tasks will have similar feature representations. This allows for the number of model parameters to be reduced. In one example embodiment, the task embedding uses a one hot encoding technique, although any number of well-known embedding techniques may be applied. In one hot encoding, categorical (classified) variables may be converted into a form that may be interpreted by algorithms performing the model prediction. For example, if a user behavior is to purchase a car, and the user is looking at four (4) vehicles—a VW, an Acura, a first Honda and a second Honda, each with different pricing, the behavior may be represented in the following table:

| Company | Category | |
|---|---|---|
| Name | Value | Price |
| VW | 1 | 20000 |
| Acura | 2 | 10011 |
| Honda | 3 | 50000 |
| Honda | 3 | 10000 |

In the above-table, the category value represents the numerical value of the entry in the dataset.

The one hot encoding transforms the table into:

| VW | Acura | Honda | Price |
|---|---|---|---|
| 1 | 0 | 0 | 20000 |
| 0 | 1 | 0 | 10011 |
| 0 | 0 | 1 | 50000 |
| 0 | 0 | 1 | 10000 |

After one hot encoding, ‘0’ indicates non-existent (“off”) while ‘1’ indicates existent (“on”). Using the one hot encoder to perform a “binarization” of the category, it may then be used as a feature to train the network 701b with an embedding layer for each category. For example, each of layers 706a, 706b and 706c have a corresponding embedding vector 706a(1), 706b(1) and 706v(1), respectively.

Similar to the embodiment in FIG. 7A, the discrete features vector 702 and continuous feature vector 704 are used to represent category information related to a user (e.g., user behavior or task), such as using an app or the number of times an app is used. In the example of FIG. 7B, the inputs additionally provide for category embedding, and thereby can provide insight into category similarities. That is, with embedding, similar categories may be mapped to nearby regions in the resultant embedding space. The model may then be trained to learn a numerical embedding (e.g., parameter weights) for each category of a categorical feature, based on all categories in the embedding space, which permits extraction of similarity-knowledge between categories (or classifications) based on relationships within the embedding space. Based on the discrete feature vector 702 and the continuous feature vector 704 with embedded vectors, output layer 706c outputs a prediction output 708 for a next time period indicative of a recommendation (e.g.; a predicted task).

### Learning Based on Feedback

With reference to FIG. 2, feedback tracking 204c provides a mechanism in which to analyze the quality of the analytics produced during the machine learning process and reuse these analytics in future data processing to assist in refining the models. That is, the observed feedbacks (used as groundtruth) are reused to train new versions of the model. For example, when testing a model after training, the outputs are given a prediction score, with higher scores meaning a higher level of confidence in its predictions. Outputs with a high prediction score may be auto-labeled with the prediction classification. For outputs with a lower prediction score (failing to satisfy a threshold), the input may be verified by labelers and the results corrected (based on feedback). These results may then be fed back to the system to further refine the model.

### Model Refinement

As user behavior(s) and context change, user behavior data is continuously tracked in order to refine and adapt the learning model. In one example embodiment, model refinement 204d (FIG. 2) includes a data buffer that stores the collected data after categorization and labeling. For example, the buffer may be an on-device (e.g., smart phone) dequeue data buffer that is created to store labeled observation data (categorized data) for training the model. As the buffer becomes full, older data may be removed from the front of the data buffer and new data may be appended to the end of the data buffer. For example, the rate of data deletion of data in the buffer may be proportional to the user behavior distribution, i.e., examples of rarest behavior are deleted slowly compared to frequent behaviors. Although the embodiment describes a dequeue buffer, it is appreciated that storage of data in continuous learning models may be implemented according to many different well-known techniques and is not limited to the embodiments described herein. The model (ƒ_{θ}) for task-N(i.e., the user behavior) may then be trained by minimizing the following 12-regularized cross-entropy loss function:

$$L ( {θ}_{N} ) = - \frac{1}{\vert {\tilde{𝒟}}_{N} \vert} {\sum }_{( ϕ ( {x}^{i} ) , {y}_{N}^{i} ) ϵ {\tilde{𝒟}}_{N}} [ {y}_{N}^{l} log {f}_{θ} ( ϕ ( {x}^{i} ) ) + ( 1 - {y}_{N}^{i} ) log ( 1 - {f}_{θ} ( ϕ ( {x}^{i} ) ) ] + \frac{λ}{2} \sum {‖ {θ}_{N} ‖}_{2}^{2} ,$$

where θ_{N} is model parameter for task-N, ∅(xⁱ) is the feature vector for observation xⁱ, yₙⁱ is the class label of task-N corresponding to xⁱ, [symbol] is the dataset sampled from the buffer for task-N, and is the regularization parameter.

In one embodiment, in the case of imbalanced data classification, the weight loss function is weighted with class weights inversely proportional to the class distribution. In one other embodiment, parallel systems for different density classes of tasks are used.

On-device learning using continuous model refinement provides real-time prediction with efficient on-device computing. Since model training can be executed on the user computing device (using, for example, Tensorflow Lite), the user computing device retains the user's data privacy and reduces latency and cloud connectively since the operations may be performed on the device. When across-device learning is used during operation, model performance may be improved through knowledge sharing across the devices (via cloud servers) without accessing user's raw and private data.

### Prediction and Learning with Adaptive Thresholding

After the model has been trained, the prediction and learning environment 206 applies the learned (trained) model 206a to provide a recommendation to the user based on the prediction 206c. The predicting process may employ, for example, a predictive model trained using machine learning to predict subsequent user behaviors based, at least in part, on current user behaviors. In one embodiment, the computing device 134 of the user can proactively send notifications and/or recommendations to users. The notification and recommendation can include, for example, a text, visual and/or audio notification.

In one embodiment, the precision of the prediction 206c may be based on a threshold 206b which ensures that the prediction 206c satisfies a level of confidence (i.e., the confidence that the system has that the prediction score is accurate). In one embodiment, the confidence of the prediction 206c can be measured using a precision metric. The precision metric quantifies the number of correct positive predictions made by the network, for example, based on the confidence of the score output during training of the network. For an imbalanced data classification for a single class, precision is calculated as the ratio of correctly predicted positive examples divided by the total number of positive example that were predicted. In the case of multi-class classification, precision may be measured as the sum of true positives across all classes divided by the sum of true positives and false positives across all classes.

In one embodiment, the level of confidence may determine whether the classification of data is accurate. If the level of confidence is not satisfied, the model may require retraining to prevent false positive outcomes. In this case, the prediction 206c may use a previously observed label to provide a recommendation, or may not provide any recommendation at all. In the case where the level of confidence is satisfied, the recommendation based on prediction 206c may be output to the user. In either case, the confidence may be measured against the threshold 206b. The threshold 206b, as explained below, may continuously change (i.e., adapt) as it learns the behavior of users.

In particular, the threshold 206c may be learned for a class “c” of task-N (δ_{c}^{N}) adaptively over time. That is, the threshold is learned (may change) over time and may serve as a basis for the level of confidence when making predictions. In one embodiment, if the level of confidence is greater than or equal to the threshold (δ_{c}^{N}), the system is confident and provides the prediction 206c to the user 130. Otherwise, infer the label of the most recently observed data instance for task-N. The threshold 206c (δ_{c}^{N}) is learned as follows:
1. Fit a Gaussian distribution N(μ_{c}^{m},(σ_{c}^{m})²) over acquired samples Ŷ_{c}^{m} of prediction scores of correct predictions for class label c of task-m;
2. Compute the threshold 206c (δ_{c}^{N}) as follows: δ_{c}^{N}=min(0.9, μ_{c}^{m}−σ_{c}^{m} (The threshold is empirically set at a maximum of 90% to deal with extreme cases. However, other percentages may be used.); and
3. Update δ_{c}^{N} over a time period (response window) with new experiences (or predictions).

Using the threshold 206c (δ_{c}^{N}) the precision of prediction may be improved significantly over traditional prediction mechanisms.

### Life-Long Meta-Learning: Transferring Knowledge Across Tasks and User

With continued reference to FIG. 2, the model database 208 (i.e., shared knowledge base) stores trained models to facilitate across-device learning via lifelong meta-learning. In Lifelong meta-learning or lifelong learning, machine learning continuously learns, accumulates the knowledge learned in the past, and uses and adapts it to help future learning and problem solving. During the process, the learned models become more and more knowledgeable and, as a result, better at learning. The knowledge gained from lifelong machine learning may be transferred across users and tasks, referred to as transfer learning. In transfer learning, a model trained on one task is re-purposed on a second related task. That is, storing knowledge gained while solving one problem and applying it to another, similar problem.

In one embodiment, the model database 208 is deployed in a server (e.g., in the cloud) that stores the trained model parameters without raw data (for privacy protection) and analysis results. In another embodiment, model database 208 resides in the computing device 132-136 of user 130.

Learning similarities between user behaviors is useful to transfer knowledge for learning across users and tasks. In the discussions that follow, three stages of learning different situational similarities are addressed: like-minded users (users with similar behavior) for the same task learning, task similarity learning and knowledge transfer to learn new tasks.

### Similarity Learning

Learning the similarity between user behaviors (e.g. behavior of two users) assists in transferring knowledge for learning across devices. We assume two parameters θₘ^{l} and θₘ² for models learned for a task ‘m’ for two users u₁ and u₂, respectively. These parameters encode the behavioral knowledge of the corresponding user u₁ and u₂ for the task ‘m.’ If for a given task, the models learned for the two users u₁ and u₂ have similar (learned) parameters, the two users u₁ and u₂ are said to be “like-minded” with respect to task ‘m.’ As these parameters are weight matrices for a neural network, their similarities can be measured using the Frobenius matrix norm:

$$sim ( {u}_{1} , {u}_{2} ; m ) = \frac{1}{1 + \sqrt{{\sum }_{i} {\sum }_{j} {\vert {{θ}_{m}^{1} ( i , j )}^{□} - {θ}_{m}^{2} ( i , j ) \vert}^{2}}} ,$$

and the similarity of the two users u₁ and u₂ for all tasks can be measured as: sim(u₁, u₂)=Σm∈M_{1,2} sim(u₁, u₂; m), where M_{1,2} is the set of all common learned tasks between u₁ and u₂.

Task-similarity learning is useful for transferring knowledge to predict new tasks or behaviors, such as predicting which app on a mobile device the user will be expected to open based on behaviors. That is, task (such as apps on a mobile device) usage prediction can be learned by transferring knowledge from a like-minded user and from similar apps. For example, a like-minded user using Adobe Reader may transfer knowledge to predict actions about a user using a Kindle app. In one embodiment, an apps meta-data information (e.g., category, textual description etc.), such as illustrated in FIG. 5, provides useful information to measure the similarity between any two apps. Given a target app (e.g., a task or action to predict) and a set of source apps (source_app_set, apps currently or previously used), the most similar app can be found as follows:
1. Find a subset of apps (candidate_app_set) from source_app_set with identical category to the target app;
2. Treat text description (meta-data) of each candidate app as one document;
3. Employ Vector Space Model (e.g., an information retrieval method, such as described in “A brief review on multi-task learning,” Multimedia Tools and Applications, KH Thung and CY Wee, pages 29705-29725, 11 2018) to measure document similarity as app similarity with target app;
4. Sort and find the most similar app (within the source apps) to the target app.

Two examples are described below in which users with similar behaviors are assumed to react similarly and engage in similar types of activities. To transfer knowledge for learning new tasks, knowledge about the users behaviors are learned and accumulated for storage in model database 208, and the information is leveraged into behavioral patterns of similar users.

In a first example, there is an existing user existing user with a new task. Given a target user u, a target (new) task ‘n’ and a candidate sample user set Ũ (source set), find the most similar learned task from the most like-minded user in Ũ:
1. Compute task (app) similarity sim(n,m) for all source tasks (apps) m ∈M. Where M is set of all learned tasks (models) for all users in Ũ using a Vector Space Model. The sim(n,m) is a global knowledge (not user dependent) and is computed only once, and stored in the model database 208.
2. Compute user similarity sim(u, uⱼ) for all uⱼ ∈Ũ.
3. Choose the most similar learned task m* from a most like-minded user u*∈Ũ to transfer knowledge for learning θₙ^{u}, as follows:

θₙ^{u}=θ_{m*}^{u*}=argmax_{uj∈Ũ,m∈M}s̅i̅m̅(̅n̅,̅m̅)̅*s̅i̅m̅(̅u̅,̅u̅ⱼ̅)̅.̅

In a second example, there is a new user with a new task. The system can leverage the knowledge of global (e.g., all users) behavioral patterns for the task, and use ensemble learning: Predict class label of the task using learned models for all users Ũ and for a given observation, and apply a voting mechanism to choose the class label with the highest probability. By virtue of the ensemble learning, the issue of a “cold-start” with new users is eliminated. That is, new users may learn from the knowledge of global behavioral patterns and need not begin the learning process from scratch.

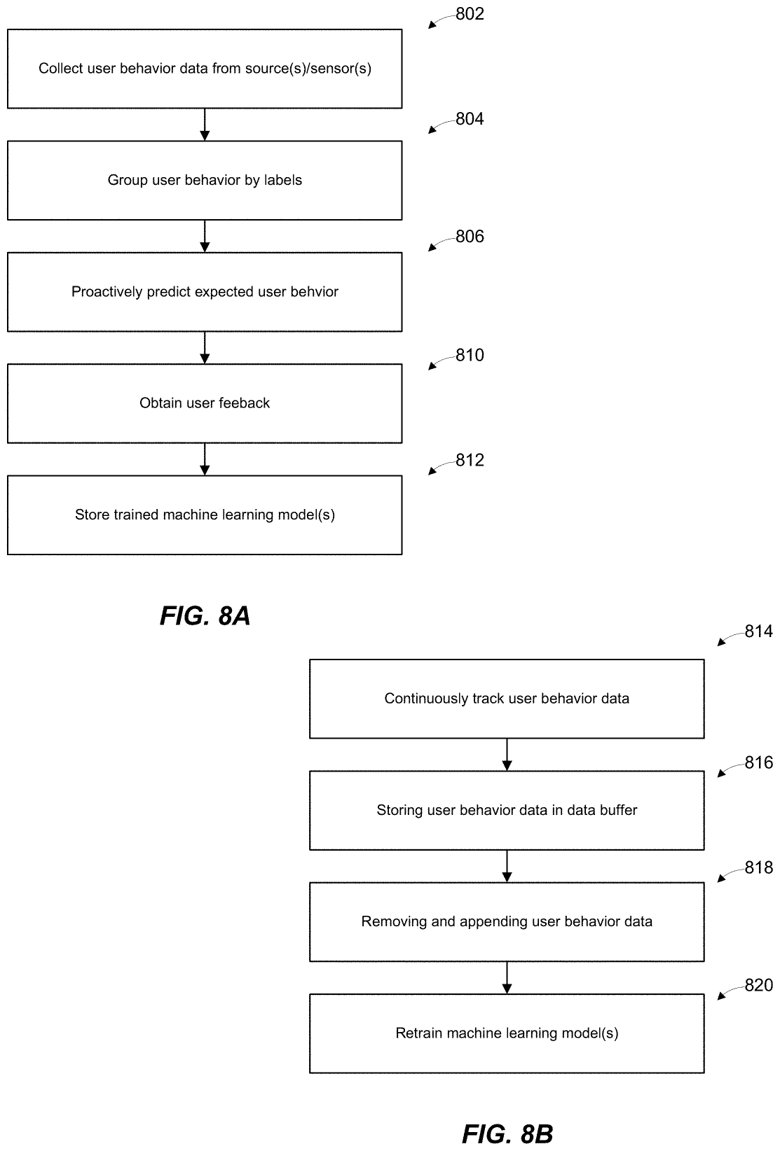

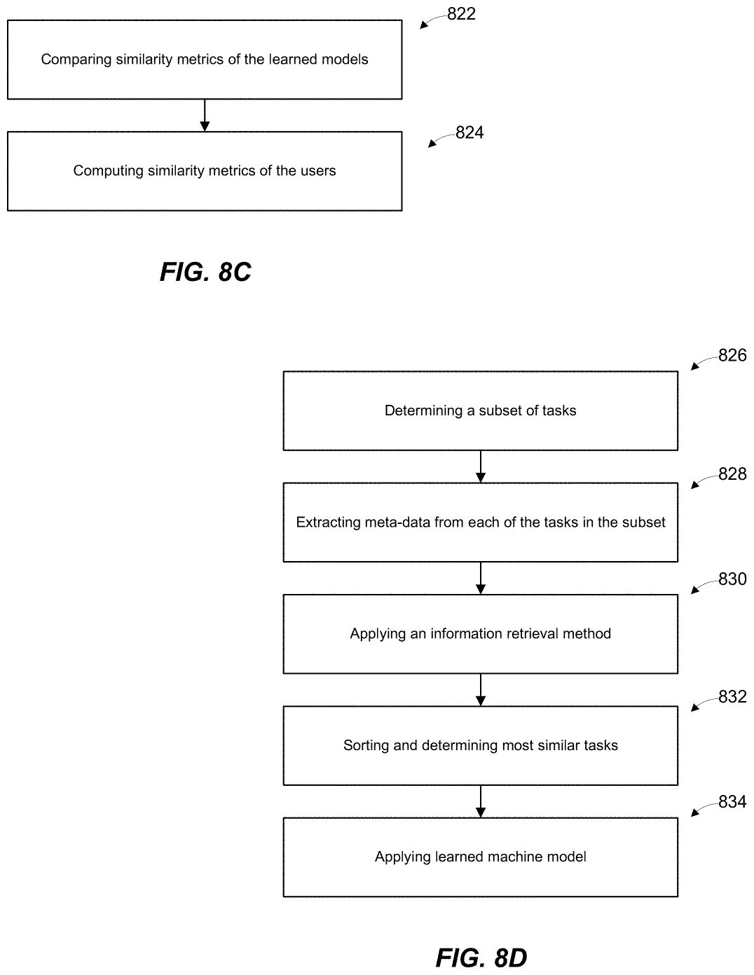

FIGS. 8A-8D illustrate flow diagrams for recommending tasks to a user based on learned behavior in accordance with embodiments of the disclosure. In the discussion that follows, the prediction system or personal assistant performs the procedures. However, it is appreciated that any other functional unit or processing unit may implement the processes described herein, and the disclosure is not limited to implementation by the prediction system or persona assistant.

In one embodiment, the personal assistant provides recommendations to a user based on learned user behavior. User behavior data is collected at step 802, from one or more sources, of a first user during a current time interval in relation to a context of a surrounding environment. The collected user behavior data is enriched with associated information, such as geocoding or meta-data information. At step 804, the user behavior data is grouped by labels, where each of the grouped user behavior data is labeled with a corresponding task classification. The grouped user behavior data trains a first machine learning model. Expected user behavior data is then proactively predicted, at step 806, during a future time interval by applying the trained first machine learning model to the collected user behavior data. A task is recommended to the first user based on the expected user behavior and a threshold associated with each task classification. Changes to the user behavior data can be made at step 810 after obtaining feedback from the user and continuously learning patterns in the collected user behavior data to refine the trained machine learning model. At step 812, the trained machine learning model is stored into a knowledge base for continued and multi-task learning.

In another embodiment, the persons assistant refines the trained machine learning models by continuously tracking the user to collect additional user behavior data, at step 814, and stores the additional user behavior data in a data buffer, at step 816, such that the additional user behavior data is stored in a time sequence. At step 818, the additional user behavior data stored in the data buffer that appears earlier in the time sequence is removed, and the additional user behavior data stored in the data buffer that appears later in the time sequence is appended, when the data buffer is full. The machine learning model may then be retrained with the user behavior data remaining in the data buffer, at step 820.

In one further embodiment, detecting similarities by the personal assistant includes comparing similarity metrics between the trained machine learning model of the user and a trained machine learning model of another user for a same task, at step 822. The similarity metrics of the users are then computed at step 824 for the trained machine learning models.

In still another embodiment, detecting similarities by the personal assistant includes, at step 826, determining a subset of tasks from the group of tasks, where the subset of tasks have a same task classification as the task to be predicted. Meta-data from each of the tasks in the subset of tasks is extracted into a single document at step 828, and an information retrieval method is applied at step 830 to measure the document similarity as the task similarity with the task to recommend. At step 832, the personal assistant sorts and determines the most similar task within the group of tasks to the task to recommend, and applies the associated learned machine model for the task to recommend at step 834.

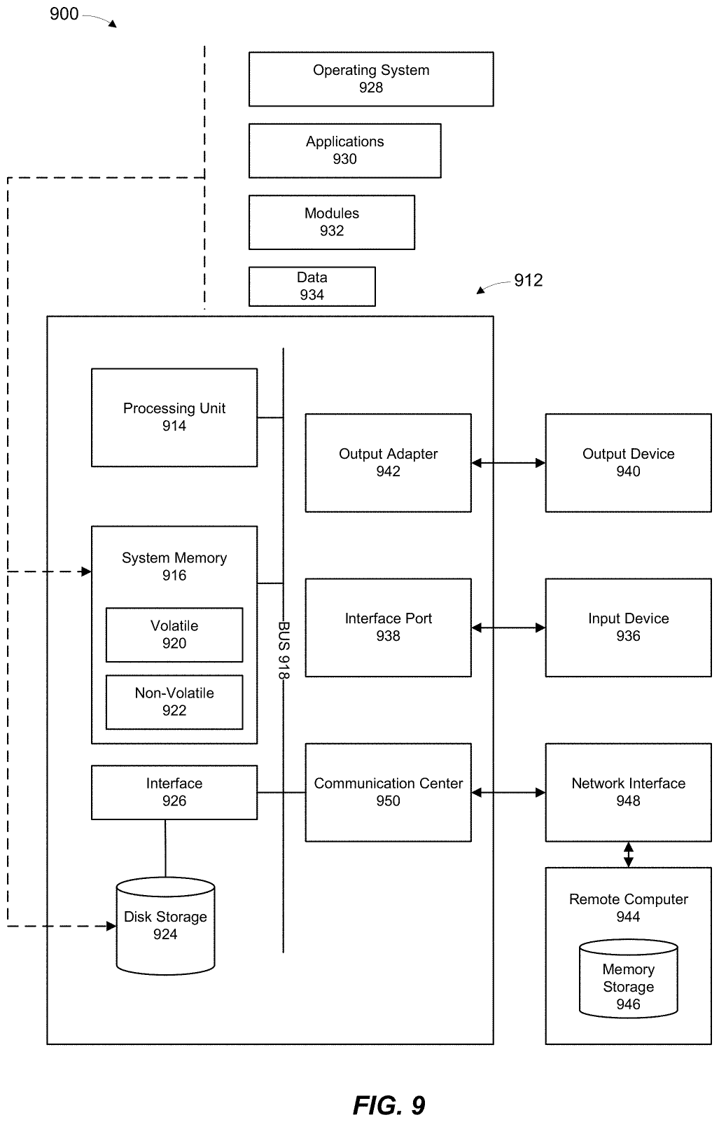

FIG. 9 shows an example embodiment of a computing system for implementing embodiments of the disclosure. A suitable operating environment 900 for implementing various aspects of this disclosure can include a computer (or mobile device) 912. The computer 912 can also include a processing unit 914, a system memory 916, and a system bus 918. The system bus 918 can operably couple system components including, but not limited to, the system memory 916 to the processing unit 914. The processing unit 914 can be any of various available processors. Dual microprocessors and other multiprocessor architectures also can be employed as the processing unit 914. The system bus 918 can be any of several types of bus structures including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire, and Small Computer Systems Interface (SCSI). The system memory 916 can also include volatile memory 920 and nonvolatile memory 922. The basic input/output system (BIOS), containing the basic routines to transfer information between elements within the computer 912, such as during start-up, can be stored in nonvolatile memory 922. By way of illustration, and not limitation, nonvolatile memory 922 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). Volatile memory 920 can also include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 912 can also include removable/non-removable, volatile/non-volatile computer storage media. FIG. 9 illustrates, for example, a disk storage 924. Disk storage 924 can also include, but is not limited to, devices like a magnetic disk drive, floppy disk drive, tape drive, Jaz drive, Zip drive, LS-100 drive, flash memory card, or memory stick. The disk storage 924 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 924 to the system bus 918, a removable or non-removable interface can be used, such as interface 926. FIG. 9 also depicts software that can act as an intermediary between users and the basic computer resources described in the suitable operating environment 900. Such software can also include, for example, an operating system 928. Operating system 928, which can be stored on disk storage 924, acts to control and allocate resources of the computer 912. System applications 930 can take advantage of the management of resources by operating system 928 through program modules 932 and program data 934, e.g., stored either in system memory 916 or on disk storage 924. It is to be appreciated that this disclosure can be implemented with various operating systems or combinations of operating systems. A user enters commands or information into the computer 912 through one or more input devices 936. Input devices 936 can include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices can connect to the processing unit 914 through the system bus 918 via one or more interface ports 938. The one or more Interface ports 938 can include, for example, a serial port, a parallel port, a game port, and a universal serial bus (USB). One or more output devices 940 can use some of the same type of ports as input device 936. Thus, for example, a USB port can be used to provide input to computer 912, and to output information from computer 912 to an output device 940. Output adapter 942 can be provided to illustrate that there are some output devices 940 like monitors, speakers, and printers, among other output devices 940, which require special adapters. The output adapters 942 can include, by way of illustration and not limitation, video and sound cards that provide a means of connection between the output device 940 and the system bus 918. It should be noted that other devices and/or systems of devices provide both input and output capabilities such as one or more remote computers 944.

Computer 912 can operate in a networked environment using logical connections to one or more remote computers, such as remote computer 944. The remote computer 944 can be a computer, a server, a router, a network PC, a workstation, a microprocessor based appliance, a peer device or other common network node and the like, and typically can also include many or all of the elements described relative to computer 912. For purposes of brevity, only a memory storage device 946 is illustrated with remote computer 944. Remote computer 944 can be logically connected to computer 912 through a network interface 948 and then physically connected via communication connection 950. Further, operation can be distributed across multiple (local and remote) systems. Network interface 948 can encompass wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). One or more communication connections 950 refers to the hardware/software employed to connect the network interface 948 to the system bus 918. While communication connection 950 is shown for illustrative clarity inside computer 912, it can also be external to computer 912. The hardware/software for connection to the network interface 948 can also include, for exemplary purposes only, internal and external technologies such as, modems including regular telephone grade modems, cable modems and DSL modems, ISDN adapters, and Ethernet cards.

It is understood that the present subject matter may be embodied in many different forms and should not be construed as being limited to the embodiments set forth herein. Rather, these embodiments are provided so that this subject matter will be thorough and complete and will fully convey the disclosure to those skilled in the art. Indeed, the subject matter is intended to cover alternatives, modifications and equivalents of these embodiments, which are included within the scope and spirit of the subject matter as defined by the appended claims. Furthermore, in the following detailed description of the present subject matter, numerous specific details are set forth in order to provide a thorough understanding of the present subject matter. However, it will be clear to those of ordinary skill in the art that the present subject matter may be practiced without such specific details.

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

The computer-readable non-transitory media includes all types of computer readable media, including magnetic storage media, optical storage media, and solid state storage media and specifically excludes signals. It should be understood that the software can be installed in and sold with the device. Alternatively the software can be obtained and loaded into the device, including obtaining the software via a disc medium or from any manner of network or distribution system, including, for example, from a server owned by the software creator or from a server not owned but used by the software creator. The software can be stored on a server for distribution over the Internet, for example.

Computer-readable storage media (medium) exclude (excludes) propagated signals per se, can be accessed by a computer and/or processor(s), and include volatile and non-volatile internal and/or external media that is removable and/or non-removable. For the computer, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

For purposes of this document, each process associated with the disclosed technology may be performed continuously and by one or more computing devices. Each step in a process may be performed by the same or different computing devices as those used in other steps, and each step need not necessarily be performed by a single computing device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method for providing recommendations to a user based on learned user behavior, comprising:
collecting user behavior data, from one or more sources, of a first user during a current time interval in relation to a context of a surrounding environment, the collected user behavior data enriched with associated information;
grouping the user behavior data by labels, each of the grouped user behavior data labeled with a corresponding task classification and the grouped user behavior data training a first machine learning model;
proactively predicting an expected user behavior data during a future time interval by applying the trained first machine learning model to the collected user behavior data, and recommending a task to the first user based on the expected user behavior and a threshold associated with each task classification;
obtaining feedback from the first user and continuously learning patterns in the collected user behavior data to refine the trained first machine learning model based on the feedback and changes to the user behavior data; and
storing the trained first machine learning model into a knowledge base for continued and multi-task learning.

2. The computer-implemented method of claim 1, further comprising collecting the user behavior data of one or more second users to continuously learn patterns in the collected user behavior data in which to predict the expected user behavior data.

3. The computer-implemented method of claim 1, wherein refining the trained machine learning model comprises:
continuously tracking the first user to collect additional user behavior data,
storing the additional user behavior data in a data buffer, wherein the additional user behavior data is stored in a time sequence;
removing the additional user behavior data stored in the data buffer that appears earlier in the time sequence and appending the additional user behavior data stored in the data buffer that appears later in the time sequence, when the data buffer is full; and
retraining the trained first machine learning model with the first user behavior data remaining in the data buffer.

4. The computer-implemented method of claim 1, wherein
the threshold is adaptively learned over a period of time and provides a basis of measurement in which to ensure that the predicting satisfies a level of confidence; and
the task is recommended to the first user when the prediction satisfies the threshold.

5. The computer-implemented method of claim 1 further comprising detecting similarities by:
comparing similarity metrics between the trained first machine learning model of the first user and a trained second machine learning model of a second user for a same task; and
computing the similarity metrics for the trained first machine learning model and the trained the second machine learning model.

6. The computer-implemented method of claim 5, wherein detecting similarities comprises combining a set of commonly learned tasks for the first and second users to determine the similarity metrics between the first and second users based on the computed similarity metrics of learned models for the tasks in the set of commonly learned tasks.

7. The computer-implemented method of claim 6, wherein detecting similarities comprises:
determining a subset of tasks from the combined set of tasks, the subset of tasks having a same task classification as the task to be predicted;
extracting meta-data from each of the tasks in the subset of tasks into a single document;
applying an information retrieval method to measure the document similarity as the task similarity with the task to recommend;
sorting and determining the most similar task within the group of tasks to the task to recommend; and
applying the associated learned machine model for the task to recommend.

8. A personal assistant on a mobile device to provide recommendations to a user based on learned user behavior, comprising:
one or more sensors for sensing user behavior data;
a non-transitory memory storage comprising instructions; and
one or more processors in communication with the memory and the one or more sensors, wherein the one or more processors execute the instructions to:
collect user behavior data, from the one or more sensors, of a first user during a current time interval in relation to a context of a surrounding environment, the collected user behavior data enriched with associated information;
group the user behavior data by labels, each of the grouped user behavior data labeled with a corresponding task classification and the grouped user behavior data training a first machine learning model;
proactively predict an expected user behavior data during a future time interval by applying the trained first machine learning model to the collected user behavior data, and recommending a task to the first user based on the expected user behavior and a threshold associated with each task classification;
obtain feedback from the first user and continuously learning patterns in the collected user behavior data to refine the trained first machine learning model based on the feedback and changes to the user behavior data; and
store the trained first machine learning model into a knowledge base for continued and multi-task learning.

9. The personal assistant of claim 8, wherein the one or more processors execute the instructions to collect the user behavior data of one or more second users to continuously learn patterns in the collected user behavior data in which to predict the expected user behavior data.

10. The personal assistant of claim 8, wherein refining the trained machine learning model causes the one or more processors to execute the instructions to:
continuously track the first user to collect additional user behavior data,
store the additional user behavior data in a data buffer, wherein the additional user behavior data is stored in a time sequence;
remove the additional user behavior data stored in the data buffer that appears earlier in the time sequence and append the additional user behavior data stored in the data buffer that appears later in the time sequence, when the data buffer is full; and
retrain the trained first machine learning model with the first user behavior data remaining in the data buffer.

11. The personal assistant of claim 9, wherein
the threshold is adaptively learned over a period of time and provides a basis of measurement in which to ensure that the predicting satisfies a level of confidence; and
the task is recommended to the first user when the prediction satisfies the threshold.

12. The personal assistant of claim 9 further including detecting similarities by causing the one or more processors to execute the instructions to:
compare similarity metrics between the trained first machine learning model of the first user and a trained second machine learning model of a second user for a same task; and
compute the similarity metrics for the trained first machine learning model and trained the second machine learning model.

13. The personal assistant of claim 12, wherein detecting similarities causes the one or more processors to execute the instructions to combine a set of commonly learned tasks for the first and second users to determine the similarity metrics between the first and second users based on the computed similarity metrics of learned models for the tasks in the set of commonly learned tasks.

14. The personal assistant of claim 13, wherein detecting similarities causes the one or more processors to execute the instructions to:
determine a subset of tasks from the group of tasks, the subset of tasks having a same task classification as the task to be predicted;
extract meta-data from each of the tasks in the subset of tasks into a single document;
apply an information retrieval method to measure the document similarity as the task similarity with the task to recommend;
sort and determining the most similar task within the group of tasks to the task to recommend; and
apply the associated learned machine model for the task to recommend.

15. A non-transitory computer-readable medium storing computer instructions for providing recommendations to a user based on learned behavior, that when executed by one or more processors, cause the one or more processors to perform the steps of:
collecting user behavior data, from one or more sources, of a first user during a current time interval in relation to a context of a surrounding environment, the collected user behavior data enriched with associated information;
grouping the user behavior data by labels, each of the grouped user behavior data labeled with a corresponding task classification and the grouped user behavior data training a first machine learning model;
proactively predicting an expected user behavior data during a future time interval by applying the trained first machine learning model to the collected user behavior data, and recommending a task to the first user based on the expected user behavior and a threshold associated with each task classification;
obtaining feedback from the first user and continuously learning patterns in the collected user behavior data to refine the trained first machine learning model based on the feedback and changes to the user behavior data; and
storing the trained first machine learning model into a knowledge base for continued and multi-task learning.

16. The non-transitory computer-readable medium of claim 15, further causing the one or more processors to perform the steps of collecting the user behavior data of one or more second users to continuously learn patterns in the collected user behavior data in which to predict the expected user behavior data.

17. The non-transitory computer-readable medium of claim 15, wherein refining the trained machine learning model causing the one or more processors to perform the steps of:
continuously tracking the first user to collect additional user behavior data,
storing the additional user behavior data in a data buffer, wherein the additional user behavior data is stored in a time sequence;
removing the additional user behavior data stored in the data buffer that appears earlier in the time sequence and appending the additional user behavior data stored in the data buffer that appears later in the time sequence, when the data buffer is full; and
retraining the trained first machine learning model with the first user behavior data remaining in the data buffer.

18. The non-transitory computer-readable medium of claim 15 further including detecting similarities by causing the one or more processors to perform the steps of:
comparing similarity metrics between the trained first machine learning model of the first user and a trained second machine learning model of a second user for a same task; and
computing the similarity metrics for the trained first machine learning model and trained the second machine learning model.

19. The non-transitory computer-readable medium of claim 18, wherein detecting similarities causing the one or more processors to perform the steps of combining a set of commonly learned tasks for the first and second users to determine the similarity metrics between the first and second users based on the computed similarity metrics of learned models for the tasks in the set of commonly learned tasks.

20. The non-transitory computer-readable medium of claim 19, wherein detecting similarities causing the one or more processors to perform the steps of:
determining a subset of tasks from the group of tasks, the subset of tasks having a same task classification as the task to be predicted;
extracting meta-data from each of the tasks in the subset of tasks into a single document;
applying an information retrieval method to measure the document similarity as the task similarity with the task to recommend;
sorting and determining the most similar task within the group of tasks to the task to recommend; and
applying the associated learned machine model for the task to recommend.
